(19) United States
(12) Patent Application Publication
(10) Pub. No.: US 2003/0155293 A1
(43) Pub. Date: Aug. 21, 2003

(54) Square-holed spiral welded filter element support sleeve

(76) Inventors: James A. McGrath, Winter Park, FL (US); James Allen Morton, Orange City, FL (US); Stephen Neubert, Edgewater, FL (US); Joseph C. Anderer, Lake Mary, FL (US); Stephen Sierens, Clermont, FL (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/082,473

(22) Filed: Feb. 21, 2002

(51) Int. Cl. B01D 29/21

(52) U.S. Cl. 210/457; 210/484; 210/489; 210/493.1; 210/497.1

(57) ABSTRACT

A filter support sleeve for use with a filter element to provide structural support for the filter element. The support sleeve encompasses the filter element and includes a metal strip wound in helical turns joined by a continuous spiral weld to form a hollow cylinder. The metal strip has substantially square perforation for passage of fluid flow through the support sleeve oriented such that when the metal strip is helically wound, a line parallel to each side of the square-shaped perforation is skew with the axial axis of the support sleeve. The support sleeve present an open structure while protecting the filter element from forces generated by the fluid flow during normal use or back flow during cleaning. When used with a pleated filter element, the support sleeve will not obstruct the entire length of the pleats.

### BACKGROUND OF THE INVENTION

1. Field of the Invention

The invention relates generally to filter elements and, more particularly, to a support sleeve for use in a filter element.

2. Description of the Related Art

Filter elements often require structural mechanical support when used in high-pressure filtering systems or when flow is reversed through the filter element in order to clean the filter. Perforated metal support sleeves have been used as a structural support member for different types of filter elements to provide mechanical strength against rupture from the “inside out” direction or from the “outside in” direction during normal filtering operations or when cleaning the filter by reversing the flow direction.

There have been improvements in the perforated metal support sleeve for filter elements over the years but the basic design of this structure has remained the same. Basically, it is a relatively thin-walled metal cylinder perforated with small holes over its total surface area. The prior design of support sleeves, however, has some drawbacks that must be overcome.

### SUMMARY OF THE INVENTION

In one embodiment, the invention is a filter support sleeve for a filter element, including at least one substantially circular end ring and a metal strip wound in a helical configuration, wherein the metal strip has at least two edges joined by a spiral weld to form a hollow cylinder. The metal strip has a plurality of substantially square-shaped perforations for passage of fluid flow through the support sleeve. In one embodiment, the perforations are oriented such that when the metal strip is helically wound, a line parallel to each of the sides of the square-shaped perforations intersects a plane encompassing the circular end ring.

In another embodiment, the invention is a filter support sleeve for a filter element, including a helical wound sheet wherein edge portions of the sheet are welded to adjacent edge portions of the sheet with a continuous spiral weld having a pitch angle between 30 and 60 degrees to form a hollow cylinder, wherein the sheet has a plurality of square perforation for passage of fluid flow through the support sleeve. In one embodiment, the perforations are oriented such that when the metal strip is helically wound, a line parallel to each side of the square-shaped perforation is skew with the axis of the support sleeve.

Another embodiment of the invention is a filter apparatus for filtering a fluid. The filter includes a cylindrical filter element. The filter also includes a filter support sleeve encompassing the filter element including at least one end ring and a metal strip wound in a helical configuration such that at least two edges of the metal strip are joined by a spiral weld to form a hollow cylinder. The metal strip has a plurality of multi-sided perforations for passage of fluid flow through the support sleeve. In another embodiment, the filter element has a plurality of pleats, wherein the pleats run parallel to the axial direction of the filter element and have a length substantially equal to the filter element, and the perforations are configured so that fluid flow is directed to each of the plurality of pleats

Another embodiment of the invention is a filter apparatus for filtering a fluid. The filter apparatus includes a cylindrical filter element. The filter apparatus also includes a filter support sleeve including at least one end ring and a metal strip wound in a helical configuration joined by a spiral weld to form a hollow cylinder, wherein the metal strip has perforation means for passage of fluid flow through the support sleeve. In another embodiment, the filter element has a plurality of pleats, wherein the pleats run parallel to the axial direction of the filter element and have a length substantially equal to the filter element, and the perforation means allows the passage of fluid flow through the support sleeve to each of the plurality of pleats

Another embodiment of the invention is a filter support sleeve for a filter element, the sleeve comprising a metal body having parallel edges, the body having a plurality of openings, wherein the openings include at least three substantially straight sides. In one embodiment, the metal body is wound in a helical conformation, and the edges are bonded in a helical weld to form a cylindrical structure. In another embodiment, the edges of the metal body are bonded along a length of the sleeve, such that the edges when bonded, are in parallel contact.

### BRIEF DESCRIPTION OF THE DRAWINGS

FIG. 1 is a top view of a metal strip 10 with square perforations used in one embodiment of a support sleeve.

FIG. 2 is a perspective view of a helical wound, spiral welded support sleeve with square holes for a filter element according to one embodiment of the invention.

FIG. 3 is a perspective view of a filter element used with the support sleeve of FIG. 2.

### DETAILED DESCRIPTION OF THE INVENTION

A detailed description of a preferred embodiment of the invention is provided below. While the invention is described in conjunction with that preferred embodiment, it should be understood that the invention is not limited to any one embodiment. On the contrary, the scope of the invention is limited only by the appended claims and the invention encompasses numerous alternatives, modifications and equivalents. For the purpose of example, numerous specific details are set forth in the following description in order to provide a thorough understanding of the invention. The invention may be practiced according to the claims without some or all of these specific details. For the purpose of clarity, technical material that is known in the technical fields related to the invention has not been described in detail so that the invention is not unnecessarily obscured.

Filter elements used in pressurized systems often require structural mechanical support in the form a support sleeve. However, the use of support sleeves requires the necessity to balance the “open area,” or the perforations or holes provided in the sleeve that allows fluid flow to reach the filter element, with the required structural strength of the sleeve. To provide sufficient structural strength of the sleeve, it is typically necessary to limit perforations to only a fraction of the total surface area of the cylinder wall. This reduces the flow rate and the efficiency of the filter element. The sleeve can be fabricated with a helical or spiral weld to provide additional structural strength to the sleeve.

Additionally, many filter elements have pleats to increase the surface area of the filter element. Often, the support sleeve acts as an obstruction along the length of several of these filter element pleats. Consequently, a need still exists for an improved filter support sleeve design that permits increased open area and increases the efficiency of the filter element.

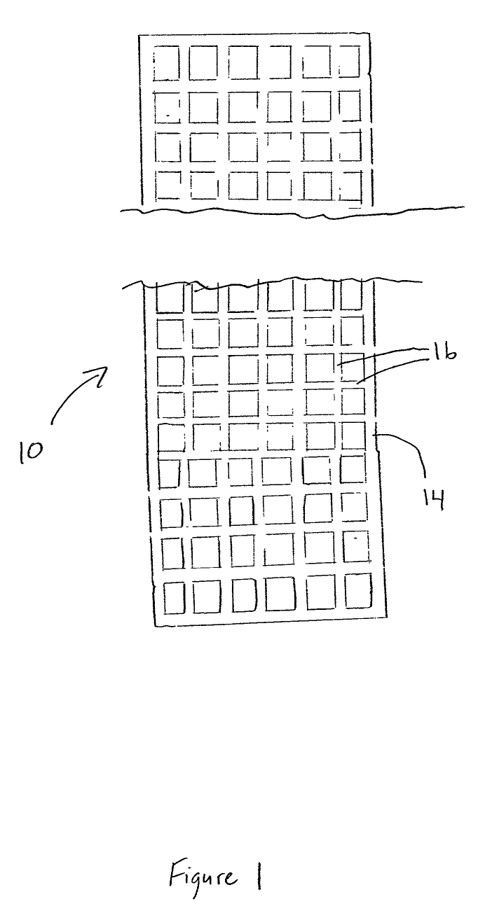

Referring now to the drawings, FIG. 1 illustrates a metal strip 10 that is generally a flat sheet of metal shaped in substantially a long rectangular strip that is used in the construction of a support sleeve as will be described below. In one embodiment, the metal strip 10 is four inches wide and 48 inches in length, however, any other useful widths and lengths for the metal strip 10 are equally possible and are within the scope of the invention. The metal strip 10 has a number of perforations 12 arranged along the length of the strip in parallel rows. In one embodiment, the perforations 12 are substantially square-shaped. In one embodiment, the substantially square-shaped perforations have sides that are 0.375 inches long. In this embodiment, the center of adjacent square-shaped perforations 12 are 0.5 inches apart in both the transverse and lengthwise directions. When used as a support sleeve for a filter, this arrangement of the metal strip 10 provides an open area of approximately 56%. One skilled in the art will understand, however, that any other useful dimensions for the perforations 12 are equally possible. For instance, in other preferred embodiments, the length of the sides of the perforations 12 may be, for example, 0.1, 0.25, 0.50, 0.75 or 1.0 inches, or more, and distances between centers may be, for example, 0.2, 0.3, 0.5, 0.7, 0.9, 1.2, 1.4, 1.6, 1.8, or 2.0 inches or more. Other perforation configurations are also conceived, such as staggering the rows of perforations 12 in a brick-like fashion. Additionally, the perforations 12 can have a substantially rectangular shape. Other perforation shapes are also contemplated, such as, for example, triangles, hexagons, octagons, and the like, to the extent that such shapes permit a high degree of open area on the surface of the sleeve. And have straight edges

Preferably, the portion of the metal strip 10 forming an outer margin band 14 is free from perforations 12 and forms a solid border surrounding lattice bands 16 created by the perforations 12 in the interior portion of the metal strip 10. In one embodiment, the outer margin band 14 is one half the width of the lattice bands 16 in the interior portion of the metal strip 10. In another embodiment, the outer margin band 14 is wider than one half the width of the lattice bands 16. An advantage of the wider margin band 14 is that the wider band provides a better welding surface.

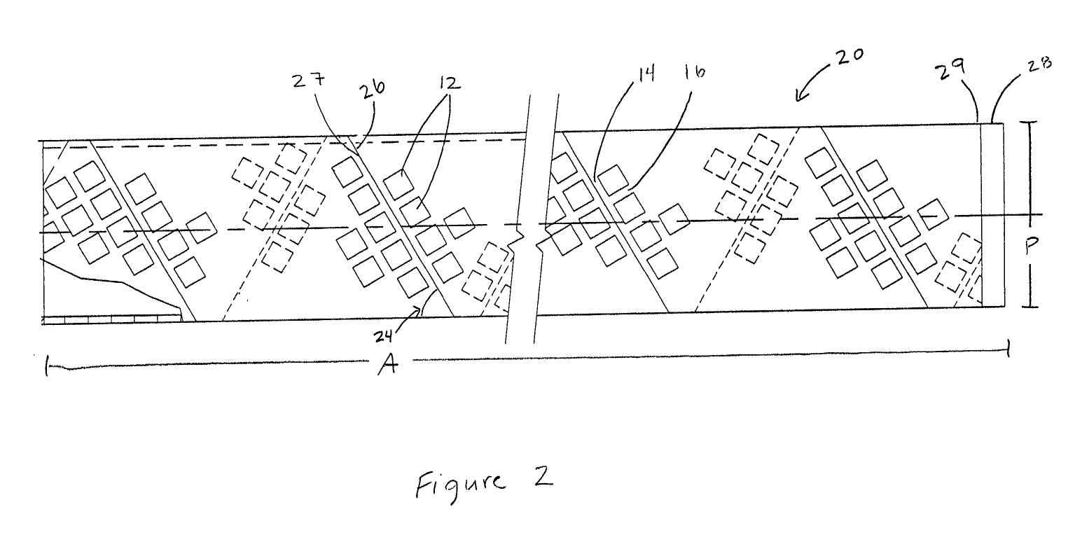

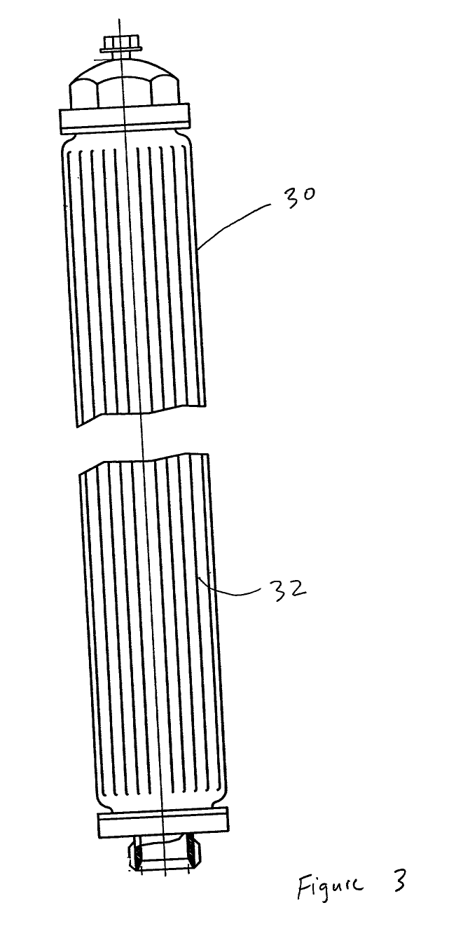

FIG. 2 illustrates a filter support sleeve 20 according to one embodiment of the invention, for use with a filter element, such as a pleated filter 30 seen in FIG. 3. The filter support sleeve 20 includes the metal strip 10 wound in a helical configuration so as to define a cylinder in profile having a central longitudinal axis A and an outer perimeter P. More particularly, the metal strip 10 can be wound in a helical configuration around a mandrel at an angle. Preferably, the metal strip 10 is wound so that the outer margin band 14 has a pitch angle 24 of between 30 to 60 degrees, and more preferably, about 45 degrees. Other pitch angles are also contemplated by the invention. A desirable pitch angle can be selected by taking into account manufacturing parameters, material strength, and necessary performance specifications. For example, a shallow pitch angle permits or requires a greater total length of weld. Depending on the performance objectives of a given sleeve, this may be desirable or undesirable. Following the teachings of the present disclosure, a skilled artisan can select a pitch angle that permits a desirable combination of ease of manufacture, strength, and other performance characteristics.

The contact points 26 along the outer margin band 14, where portions of the outer margin band are adjacent other portions of the outer margin band, are welded together. The contact points 26 can be welded using a standard fusion weld as is known by one skilled in the art. Also, one skilled in the art will understand that other methods of joining the contact points can be used. In one embodiment, a continuous spiral weld 27 spirals around the entire length of the support sleeve 20 and is used to join the contact points 26. Preferably, the metal strip 10 is wound such that any protrusions cause by perforating the metal strip 10 point in the outward direction to reduce the risk of damaging the filter element inside the support sleeve 20. The solid margin and spiral weld design of the invention has much greater structural strength than that sleeves that are welded only along a straight length of the sleeve. In preferred embodiments, an end ring 28 is welded to one or both ends 29 of the support sleeve 20.

In one embodiment, the support sleeve 20 is made of 316 stainless steel, with a thickness of 0.024 inch. Alternately, other 300 series stainless steel, such as 304, or other corrosion resistant metals such as Hastelloy®, Inconel®, and the like can be used. Larger thickness can be used where greater strength is required or a smaller thickness can be used where less strength is required.

By way of an example, support sleeve 20 shown in FIG. 2 is 24 inches in length and has an outside diameter of 2.75 inches. One skilled in the art will understand, however, that any other useful lengths and diameters are possible. Lengths may range, for example, from 2 inches to 60 inches, or more, and outside diameters may range, for example, from 0.75 to 14 inches, or more.

FIG. 3 illustrates a filter element 30 having a cylindrical shape that can be disposed inside the filter support sleeve 20. In this embodiment, the filter support sleeve 20 provides strength to support the filter element 30 from fluid flowing in a direction from inside to outside the filter element 30. In another embodiment, the filter support sleeve 20 can be placed inside the core of the filter element 30. In this embodiment, the filter support sleeve 20 provides strength to support the filter element 30 from fluid flowing from the outside to the inside of the filter element. The filter element 30 may consist of a woven or non-woven material of metal fibers, paper or fabric, depending on the pressure and volume of fluid, and the size of the particulate matter that has to be intercepted. The filter element 30 can have pleats 32 running along the axial length of the filter element 30 to increase the surface area of the filter element. Likewise, the support sleeve 20 is also suitable and desirable for use with non-pleated filter elements.

The square-holed/spiral wrap design of the support sleeve 20 offers several advantages over sleeves with traditional round holes. For example, when the support sleeve 20 is used with a pleated filter element 30 having pleats 32 that run along the axial dimension of the filter element, having the square-holed pattern oriented at an angle relative to the pleats 32 improves the flow characteristics through the filter element 30 in both the forward and reverse directions relative to round perforations or square perforations oriented at a zero degree angle. When the square perforations 12 are oriented at an angle of, for example, 45 degrees, to the pleats 32, the cleaning fluid flow is not obstructed along the length of the pleats 32, thereby yielding better flow through the filter element 30 and better cleaning of the filter element 30. This improvement may be partially due to a decreased obstruction along the filter element pleats because the support sleeve 20 does not blind off the entire top area of any of the pleats. This improvement in flow increases the efficiency of the filter element and also makes the filter element easier to clean. Using substantially square-shaped perforations 12 further allows for more open area while providing better strength characteristics than typical round perforations.

The foregoing description details certain embodiments of the invention and describes the best mode contemplated. Specific parts, shapes, materials, functions and modules have been set forth. However, a skilled technologist will realize that there are many ways to fabricate the system of one embodiment of the invention, and that there are many parts, components, modules or functions that may be substituted for those listed above. While the above detailed description has shown, described, and pointed out fundamental novel features of the invention as applied to various embodiments, it will be understood that various omissions and substitutions and changes in the form and details of the components illustrated may be made by those skilled in the art, without departing from the spirit or essential characteristics of the invention. The scope of the invention should therefore be construed in accordance with the appended claims and any equivalents thereof.

What is claimed is:

1. A filter support sleeve for use with a filter element, the support sleeve comprising at least one substantially circular end ring and a metal strip wound in a helical configuration, wherein the metal strip has at least two edges joined by a spiral weld to form a hollow cylinder, wherein the metal strip has a plurality of substantially square-shaped perforations for passage of fluid flow through the support sleeve.

2. The filter support sleeve of claim 1, wherein the perforations are oriented such that when the metal strip is helically wound, a line parallel to each one of the sides of the square-shaped perforations intersects a plane encompassing the circular end ring.

3. The filter support sleeve of claim 1, wherein the perforations are arranged in a plurality of parallel rows.

4. The filter support sleeve of claim 1, wherein the perforations are arranged in a plurality of staggered rows.

5. The filter support sleeve of claim 1, where an outer margin band of the metal strip is free from perforations.

6. The filter support sleeve of claim 5, wherein the metal strip is wound such that the outer margin band of the metal strip has a pitch angle of between 30 and 60 degrees.

7. The filter support sleeve of claim 1, wherein the metal strip is stainless steel.

8. A filter support sleeve for a filter element, comprising at least one end ring and a metal strip, wherein the metal strip is wound in a helical configuration joined by a spiral weld to form a hollow cylinder, and wherein the metal strip has a plurality of multi-sided perforations for passage of fluid flow through the support sleeve oriented such that when the metal strip is helically wound, a line parallel to each of the sides of the multi-sided perforations intersects a plane encompassing the circular end ring.

9. The filter support sleeve of claim 8, wherein the perforations are arranged in a plurality of parallel rows.

10. The filter support sleeve of claim 8, wherein the sides of the perforations are substantially straight.

11. The filter support sleeve of claim 8, wherein the perforations are substantially square-shaped perforations.

12. The filter support sleeve of claim 8, where an outer margin band of the metal strip is free from perforations.

13. The filter support sleeve of claim 12, wherein the metal strip is wound such that the outer margin band of the metal strip has a pitch angle of between 30 and 60 degrees.

14. The filter support sleeve of claim 8, wherein the metal strip is stainless steel.

15. A filter support sleeve for a filter element, comprising a helical wound sheet wherein edge portions of the sheet are welded to adjacent edge portions of the sheet with a spiral weld having a pitch angle between 30 and 60 degrees to form a hollow cylinder, wherein the sheet has a plurality of square perforation for passage of fluid flow through the support sleeve.

16. The support sleeve of claim 15, wherein the perforations are oriented such that when the metal strip is helically wound, a line substantially parallel to each side of the square-shaped perforation is skew with a lengthwise axis of the support sleeve.

17. A filter apparatus for filtering a fluid comprising:
a cylindrical filter element; and
a filter support sleeve supporting the filter element comprising a metal strip wound in a helical configuration, wherein two edges of the metal strip are joined by a spiral weld to form a hollow cylinder, wherein the metal strip has a plurality of multisided perforations for passage of fluid flow through the support sleeve.

18. The filter apparatus of claim 17, wherein the filter support sleeve is oriented to be outside the filter element.

19. The filter apparatus of claim 17, wherein the filter support sleeve is oriented to be inside the filter element.

20. The filter apparatus of claim 17, wherein the filter element comprises a plurality of pleats parallel to the axial direction of the filter element and have a length substantially equal to said filter element, and wherein the perforations allow the passage of fluid flow through the support sleeve to each of the plurality of pleats

21. The filter apparatus of claim 17, wherein the filter support sleeve further comprises at least one end ring, wherein a line parallel to each of the sides of the multi-sided perforations intersects a plane encompassing the end ring.

22. The filter apparatus of claim 17, wherein the perforations are arranged in a plurality of parallel rows.

23. The filter apparatus of claim 17, wherein the sides of the perforations are substantially straight.

24. The filter apparatus of claim 17, wherein the perforations are substantially square-shaped perforations.

25. The filter apparatus of claim 17, where an outer margin band of the metal strip is free from perforations.

26. The filter apparatus of claim 24, wherein the metal strip is wound such that the outer margin band of the metal strip has a pitch angle of between 30 and 60 degrees.

27. The filter apparatus of claim 17, wherein the metal strip is stainless steel.

28. A filter apparatus for filtering a pressurized fluid comprising:
a cylindrical filter element; and
a filter support sleeve comprising a metal strip wound in a helical configuration, wherein two sides of the metal strip are joined by a spiral weld to form a hollow cylinder, wherein the metal strip has perforation means for passage of fluid flow through the support sleeve.

29. The filter apparatus of claim 27, wherein the support sleeve is oriented to be outside the filter element.

30. The filter apparatus of claim 27, wherein the support sleeve is oriented to be inside the filter element.

31. The filter apparatus of claim 27, wherein the filter element comprises a plurality of pleats parallel to the axial direction of the filter element and having a length substantially equal to said filter element, wherein the perforation means allows the passage of fluid flow through the support sleeve to each of the plurality of pleats.

32. The filter apparatus of claim 27, wherein the perforation means for passage of fluid flow comprises a plurality of substantially square-shaped perforations.

33. A filter support sleeve for a filter element, the sleeve comprising a metal body having parallel edges, wherein the metal body is wound in a helical conformation, and wherein the edges are bonded in a helical weld to form a cylindrical structure, and wherein the body has a plurality of openings, wherein the openings comprise at least three substantially straight sides.

34. The filter support sleeve of claim 31, wherein the edges of the metal body are bonded along a length of the sleeve, such that the edges when bonded are in parallel contact.

35. The filter support sleeve of claim 31, comprising openings having four sides.

36. The filter support sleeve of claim 31, comprising openings having five sides.

37. The filter support sleeve of claim 31, comprising openings having at least six sides.
